(19) United States
(12) Patent Application Publication
(10) Pub. No.: US 2010/0107594 A1
(43) Pub. Date: May 6, 2010

(54) TURBINE INTEGRATED BLEED SYSTEM AND METHOD FOR A GAS TURBINE ENGINE

(75) Inventors: George Albert Coffinberry, West Chester, OH (US); Kevin Richard Leamy, Loveland, OH (US)

Correspondence Address: TREGO, HINES & LADENHEIM, PLLC, 9300 HARRIS CORNERS PARKWAY, SUITE 210, CHARLOTTE, NC, 28269, US

(73) Assignee: GENERAL ELECTRIC COMPANY, Schenectady, NY (US)

(21) Appl. No.: 12/263,030

(22) Filed: Oct. 31, 2008

(51) Int. Cl. F02C 7/047; F02C 6/08

(52) U.S. Cl. 60/39.093; 60/782; 60/39.15; 60/779

(57) ABSTRACT

A bleed system for a gas turbine engine includes: (a) a bleed air turbine having a turbine inlet adapted to be coupled to a source of compressor bleed air at a first pressure; (b) a bleed air compressor mechanically coupled to the bleed air turbine, and having a compressor inlet adapted to be coupled to a source of fan discharge air at a second pressure substantially lower than the first pressure; and (c) a mixing duct coupled to a turbine exit of the bleed air turbine and to a compressor exit of the bleed air compressor.

### BACKGROUND OF THE INVENTION

This invention relates generally to gas turbine engines and more particularly to methods and apparatus for extracting bleed air in such engines.

Turbine-powered aircraft conventionally incorporate environmental control systems (ECS) which control aircraft cabin temperature by the amount and temperature of the bleed air extracted from the engine. Historically, ECS have used engine bleed air that is extracted from a high pressure compressor (HPC), throttled (pressure reduced), and cooled by a heat exchanger (“precooler”) using fan bleed air. This is possible because metal airframes are tolerant of exposure to high temperature bleed air. Bleed air is also used to provide anti-icing to the aircraft, and must be at high temperature for this purpose—typically about 204° C. (400° F.).

Future aircraft will replace some or all of these metallic structures with composite materials to reduce weight and improve overall efficiency. These structures have limited temperature capability compared to metal alloys. For example, a typical carbon-fiber composite material may have a temperature limit substantially below 93° C. (200° F.). Conventional ECS interfaces, utilizing engine bleed air and a fan air precooler, can not meet this requirement without significantly increasing the size of the precooler. Furthermore, composite aircraft will often use electrically powered anti-ice systems and therefore do not require high temperature bleed air.

One way ECS requirements have been met in composite aircraft, is by using electrically driven ECS to pressurize and condition ambient air. While effective to provide low-pressure, low-temperature bleed air, this requires a separate air inlet to efficiently entrain ambient air and considerable electrical power to drive the ECS compressors. The electrical power requirements can require an undesirable increase in the size of the engine mounted generators.

### BRIEF SUMMARY OF THE INVENTION

These and other shortcomings of the prior art are addressed by the present invention, which provides a turbine integrated bleed system (TIBS) which is effective to extract HPC and fan bleed air from a turbine engine and provides low pressure, low temperature airflow to an aircraft environmental control system while minimizing throttling inefficiencies and the need for bleed air precooling.

According to one aspect of the invention, a bleed system for a gas turbine engine includes: (a) a bleed air turbine having a turbine inlet adapted to be coupled to a source of compressor bleed air at a first pressure; (b) a bleed air compressor mechanically coupled to the bleed air turbine, and having a compressor inlet adapted to be coupled to a source of fan discharge air at a second pressure substantially lower than the first pressure; and (c) a mixing duct coupled to a turbine exit of the bleed air turbine and to a compressor exit of the bleed air compressor.

According to another aspect of the invention, a gas turbine engine includes: (a) a turbomachinery core including a high pressure compressor, a combustor, and a high pressure turbine in serial flow relationship, the core operable to produce a first pressurized flow of air; (b) a low pressure turbine disposed downstream of the core and operable to drive a fan to produce a second pressurized flow of air; (c) a bleed air turbine having a turbine inlet coupled to the high pressure compressor; (d) a bleed air compressor mechanically coupled to the bleed air turbine, and having a compressor inlet coupled to the fan; and (e) a mixing duct coupled to a turbine exit of the bleed air turbine and to a compressor exit of the bleed air compressor.

According to another aspect of the invention, a method of extracting bleed air for a gas turbine engine includes: (a) extracting a first air flow at a first temperature and a first pressure from a compressor of the engine; (b) expanding the first air flow through a bleed air turbine so as to lower its temperature and pressure; (c) extracting a second flow at a second temperature and pressure from a fan of the engine; (d) compressing the second air flow in a bleed air compressor to raise its temperature and pressure, wherein the bleed air compressor is driven by the bleed air turbine; and (e) mixing the first and second air flows downstream of the bleed air turbomixer to create a mixed air flow.

### BRIEF DESCRIPTION OF THE DRAWINGS

The invention may be best understood by reference to the following description taken in conjunction with the accompanying drawing figures in which:

FIG. 1 is a schematic diagram of a gas turbine engine incorporating a bleed system constructed in accordance with an aspect of the present invention; and

FIG. 2 is a schematic diagram of a bleed system.

### DETAILED DESCRIPTION OF THE INVENTION

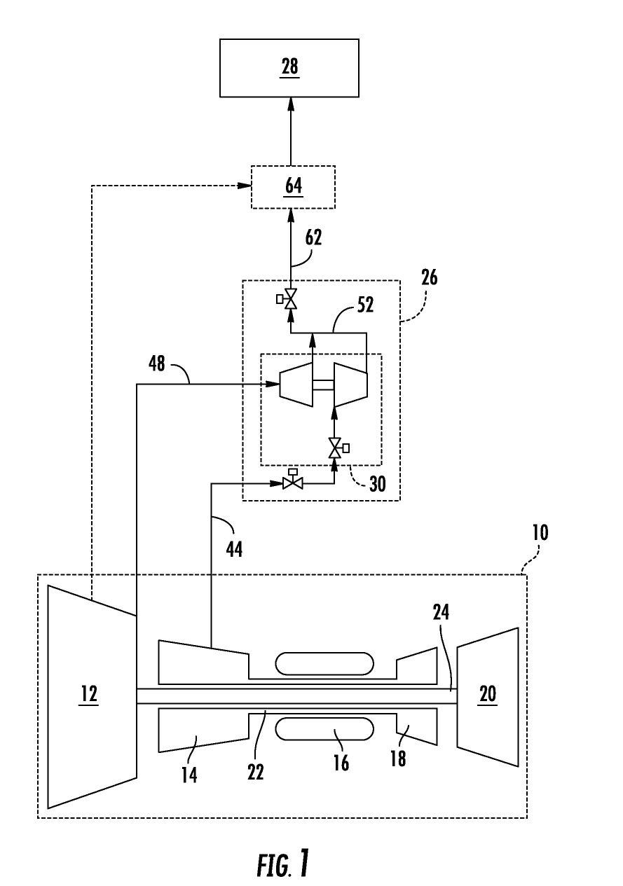

Referring to the drawings wherein identical reference numerals denote the same elements throughout the various views, FIG. 1 depicts schematically the elements of an exemplary gas turbine engine 10 having a fan 12, a high pressure compressor 14, a combustor 16, a high pressure turbine 18, and a low pressure turbine 20, all arranged in a serial, axial flow relationship. Collectively the high pressure compressor 14, the combustor 16, and the high pressure turbine 18 are referred to as a “core”. The high pressure compressor 14 provides compressed air that passes into the combustor 12 where fuel is introduced and burned, generating hot combustion gases. The hot combustion gases are discharged to the high pressure turbine 18 where they are expanded to extract energy therefrom. The high pressure turbine 18 drives the compressor 10 through an outer shaft 22. Pressurized air exiting from the high pressure turbine 18 is discharged to the low pressure turbine 20 where it is further expanded to extract energy. The low pressure turbine 20 drives the fan 12 through an inner shaft 24. The fan 12 generates a flow of pressurized air, a portion of which supercharges the inlet of the high pressure compressor 14, and the majority of which bypasses the “core” to provide the majority of the thrust developed by the engine 10.

The engine 10 incorporates a bleed system 26, referred to as a turbine integrated bleed system or “TIBS” for supplying engine bleed air to an airframe. “bleed air” generally is pressurized air which is extracted or “bled off” from the engine 10. It may be used for purposes such as anti-icing or de-icing, pressurization, heating or cooling, and operating pneumatic equipment. In particular it may be used for an environmental control system (ECS) 28. It is necessary to supply the ECS with bleed air at specified temperature and pressure conditions, and at a sufficient mass flow rate.

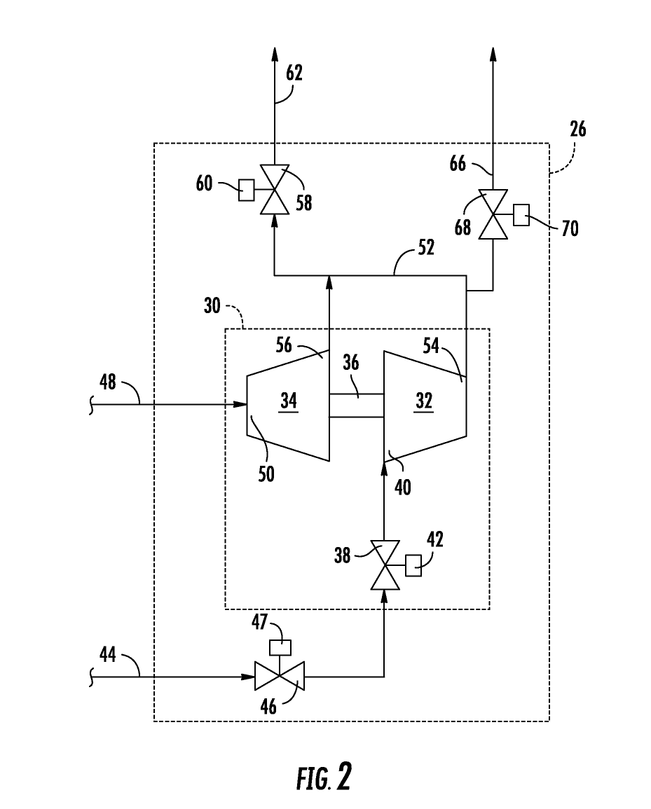

FIG. 2 illustrates the functional components of the bleed system 26 in more detail. A turbomixer 30 is provided which comprises a bleed air turbine 32 and a bleed air compressor 34 coupled by a common shaft 36. While not shown in FIG. 2, it will be understood that the bleed air turbine 32 and the bleed air compressor 34 are enclosed in suitable housings and that the shaft 36 is supported in bearings of a known type to absorb thrust and radial loads. In the illustrated example, the bleed air turbine 32 incorporates a variable-area turbine nozzle 38 at the turbine inlet 40. In accordance with conventional practice, the turbine nozzle 38 is selectively opened or closed by an actuator 42 of a known type in response to control signals, to control the bleed air flow rate to the bleed air turbine 32. This allows the turbomixer 30 to operate at peak efficiency over a wide range of pressure ratios.

An inlet duct 44 is coupled between the turbine inlet 40 and a source of high-pressure, high-temperature engine air extracted from the engine 1 0. For example this may be air flow taken at compressor discharge pressure (CDP) from the exit of the high pressure compressor 14 of the engine 10 (see FIG. 1), or it may be bled from an intermediate stage of the high pressure compressor 14. It is also known to use bleed air from an intermediate compressor stage at some operating conditions (e.g. cruise) and to use CDP air or a mixture of intermediate stage air and CDP air at other conditions (e.g. flight idle.) For the purposes of discussion this bleed flow, whether from one source or multiple sources, will be referred to as “compressor bleed air”. A combined pressure regulating and shut-off valve (PRSOV) 46 is placed in the inlet duct 44. It is operated by an actuator 47 and is effective to provide bleed air flow to the bleed air turbine 32 at a desired setpoint pressure, and to shut off bleed air flow completely when desired. Optionally, a combination of separate valve components in series may be used to achieve the same function.

Another inlet duct 48 is coupled between the discharge of the fan 12 and the inlet 50 of the bleed air compressor 34. A mixing duct 52 couples the discharge from the exit 54 of the bleed air turbine 32 and the discharge from the exit 56 of the bleed air compressor 34. As shown in FIG. 1, the mixing duct 52 is connected to the ECS system 28 by a shut-off valve (SOV) 58 which is operated by an actuator 60.

In operation, compressor bleed air at high pressure temperature is expanded across the bleed air turbine 32, reducing its pressure and temperature, while extracting mechanical work therefrom to drive the bleed air compressor 34 through the shaft 36. Engine fan discharge air, at relatively low pressure and temperature, is bled and introduced to the bleed air compressor 34. Work input from the bleed air compressor 34 increases the fan bleed air temperature and pressure. The bleed air compressor and turbine discharge streams are mixed in the mixing duct 52 and provided to the ECS 28 through the shut-off valve 58 and a discharge duct 62.

Optionally, as shown in FIG. 1, the mixed flow may be passed through an air-to-air heat exchanger (a precooler) 64, which is cooled by fan discharge air, to further reduce the mixed flow temperature. The precooler 64 may be located upstream or downstream of the turbomixer 30. An analytical example of the expected performance of the bleed system are listed in Table 1 below, for a high-bypass turbofan engine at a cruise flight condition.

TABLE 1

| | TURBINE | | COMPRESSOR | | MIXED |
|---|---|---|---|---|---|
| | INLET | OUTLET | INLET | OUTLET | OUTLET |
| TEMPERATURE | 472.9° C. | 187.1° C. | 10.3° C. | 41.4° C. | 56.0° C. |
| | (883.1° F.) | (368.7° F.) | (50.5° F.) | (106.5° F.) | (132.8° F.) |
| PRESSURE | 0.76 mPa | 75.8 kPa | 0.05 mPa | 75.8 kPa | 75.8 kPa |
| | (110 psia) | (11.0 psia) | (8.17 psia) | (11.0 psia) | (11.0 psia) |

| | | | |
|---|---|---|---|
| MASS | 0.05 kg/s | 0.45 kg/s | 0.50 kg/s |
| FLOW | (0.112 lb./s) | (1.0 lb./s) | (1.112 lb./s) |

It will be understood that this is merely one point example of an operating condition. What is significant is that the mixed flow outlet is supplied at a suitable temperature, pressure and flow rate by transferring energy from the high pressure bleed flow to the fan bleed flow. In particular the mixed flow discharge temperature is well within acceptable limits for composite materials used in aircraft structures, as noted above. The turbomixer 26 is not 100% efficient, but any losses it incurs are far less than would be expected with a conventional throttling device.

Optionally, the bleed system 26 may be configured to provide one or more auxiliary air flows in addition to the mixed flow exiting the discharge duct 62. For example, FIG. 2 shows an auxiliary duct 66 coupled to the exit 54 of the bleed air turbine 32. Flow through the auxiliary duct 66 is controlled by a shut-off valve 68 which is operated by an actuator 70. This auxiliary flow is hotter than the mixed flow, and could be used in a situation where high-temperature air, i.e. on the order of 204° C. (400° F.), is needed for aircraft anti-icing.

The bleed system 26 described herein provides a low pressure, low temperature interface to the aircraft ECS 28 that is compatible with the temperature limitations of composite aircraft while minimizing the typically throttling inefficiencies or increasing the size of the precooler. The bleed system 26 provides a low temperature interface to the ECS without adversely increasing the size of the precooler or perhaps even eliminating the precooler.

The foregoing has described a turbine integrated bleed system for a gas turbine engine. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A bleed system for a gas turbine engine, comprising:
(a) a bleed air turbine having a turbine inlet adapted to be coupled to a source of compressor bleed air at a first pressure;
(b) a bleed air compressor mechanically coupled to the bleed air turbine, and having a compressor inlet adapted to be coupled to a source of fan discharge air at a second pressure substantially lower than the first pressure; and
(c) a mixing duct coupled to a turbine exit of the bleed air turbine and to a compressor exit of the bleed air compressor.

2. The bleed system of claim 1 further comprising a pressure regulating valve disposed upstream of the bleed air turbine.

3. The bleed system of claim 1 wherein the bleed air turbine includes a variable-area inlet nozzle.

4. The bleed system of claim 1 further comprising a shut-off valve disposed downstream of the mixing duct.

5. The bleed system of claim 1 further comprising a heat exchanger coupled to the mixing duct.

6. A gas turbine engine, comprising:
(a) a turbomachinery core including a high pressure compressor, a combustor, and a high pressure turbine in serial flow relationship, the core operable to produce a first pressurized flow of air;
(b) a low pressure turbine disposed downstream of the core and operable to drive a fan to produce a second pressurized flow of air;
(c) a bleed air turbine having a turbine inlet coupled to the high pressure compressor;
(d) a bleed air compressor mechanically coupled to the bleed air turbine, and having a compressor inlet coupled to the fan; and
(e) a mixing duct coupled to a turbine exit of the bleed air turbine and to a compressor exit of the bleed air compressor.

7. The gas turbine engine of claim 6 further comprising a pressure regulating valve disposed between the turbine inlet and the high pressure compressor.

8. The gas turbine engine of claim 6 further comprising a variable-area turbine nozzle disposed between the turbine inlet and the high pressure compressor.

9. The gas turbine engine of claim 6 further comprising a shut-off valve disposed downstream of the mixing duct.

10. The gas turbine engine of claim 6 further comprising a heat exchanger coupled to the mixing duct and to the fan.

11. The gas turbine engine of claim 6 further comprising an environmental control system coupled to the mixing duct.

12. The gas turbine engine of claim 6 further comprising an auxiliary duct coupled to the exit of the bleed air turbine.

13. The gas turbine engine of claim 12 further comprising an shut-off valve disposed in the auxiliary duct.

14. A method of extracting bleed air for a gas turbine engine, comprising:
(a) extracting a first air flow at a first temperature and a first pressure from a compressor of the engine;
(b) expanding the first air flow through a bleed air turbine so as to lower its temperature and pressure;
(c) extracting a second flow at a second temperature and pressure from a fan of the engine;
(d) compressing the second air flow in a bleed air compressor to raise its temperature and pressure, wherein the bleed air compressor is driven by the bleed air turbine; and
(e) mixing the first and second air flows downstream of the bleed air turbomixer to create a mixed air flow.

15. The method of claim 14 further comprising regulating the pressure of the first air flow before it enters the bleed air turbine.

16. The method of claim 15 further comprising controlling the flow rate of the first air flow through the bleed air turbine using a variable-area turbine nozzle disposed between the turbine inlet and the high pressure compressor.

17. The method of claim 15 further comprising cooling the mixed air flow.

18. The method of claim 15 further comprising passing the mixed air flow to an environmental control system.

19. The method of claim 14 further comprising passing a portion of the first air flow which has been expanded in the turbine to an anti-icing system.
